(19) United States
(12) Patent Application Publication
(10) Pub. No.: US 2014/0176440 A1
(43) Pub. Date: Jun. 26, 2014

(54) APPARATUS AND SYSTEM FOR IMPLEMENTING A WIRELESS MOUSE USING A HAND-HELD DEVICE

(71) Applicant: NVIDIA CORPORATION, Santa Clara, CA (US)

(72) Inventors: Dhaval Sanjaykumar Dave, Ahmedabad (IN); Anup Ashok Dalvi, Pune (IN)

(73) Assignee: NVIDIA CORPORATION, Santa Clara, CA (US)

(21) Appl. No.: 13/725,130

(22) Filed: Dec. 21, 2012

(51) Int. Cl. G06F 3/0354

(52) U.S. Cl. CPC G06F 3/03543
USPC 345/163

(57) ABSTRACT

An apparatus and system are provided for implementing a hand-held device as a wireless mouse for controlling a wirelessly-connected device. The hand-held device includes a position sensor and includes an integrated case connected to the hand-held device. The case includes at least one button for providing user input.

### FIELD OF THE INVENTION

The present invention relates to an electronic hand-held device, and more particularly to a hand-held device with integrated electronic hardware.

### BACKGROUND

Mobile phones have become ubiquitous in today's digital world. Many people rely on their mobile phone to perform a whole host of varying tasks such as making phone calls, checking email, capturing digital photographs and digital video, reading news on the Internet, playing games, and so forth. The mobile phone has become the Swiss Army knife of hand-held electronics.

Still, the range of tasks that can be performed with today's smart phones (e.g., the Apple™ iPhone, or Google™ Android-based phones) is limited to the hardware supplied with the phones. For example, most phones today come with an integrated CMOS (complementary metal-oxide semiconductor) image sensor to capture pictures or video, Some phones may include a flash device (e.g., an LED flash module) to illuminate a scene. Further, many phones have internal accelerometers or gyroscopes that provide feedback about the motion of the phone. While these and other sensors enable a wide range of applications to be implemented in software on these phones, some applications require hardware that is not readily available within any existing mobile hand-held devices. Thus, there is a need for addressing this issue and/or other issues associated with the prior art.

### SUMMARY

An apparatus and system are provided for implementing a hand-held device as a wireless mouse for controlling a wirelessly-connected device. The hand-held device includes a position sensor and includes an integrated case connected to the hand-held device. The case includes at least one button for providing user input.

### BRIEF DESCRIPTION OF THE DRAWINGS

FIGS. 1A & 1B illustrate a hand-held device with integrated sensors, in accordance with one embodiment;

FIGS. 2A & 2B illustrate a case for the hand-held device of FIGS. 1A and 1B, in accordance with one embodiment;

FIG. 3 illustrates a system for configuring a hand-held device as a wireless mouse, in accordance with one embodiment;

FIG. 4 illustrates an exemplary system in which the various architecture and/or functionality of the various previous embodiments may be implemented;

FIG. 5 illustrates a parallel processing unit (PPU), according to one embodiment; and

FIG. 6 illustrates the streaming multi-processor of FIG. 5, according to one embodiment.

### DETAILED DESCRIPTION

One example application that existing hardware integrated in a hand-held device is not suited to perform is the function of a wireless mouse. While some devices incorporate some position sensing hardware, such as integrated gyroscopes or accelerometers, the form factor of the devices is typically not ergonomically suited for extended use as a wireless mouse. For example, atypical mobile phone form factor is a thin rectangle that is hard to grip and manipulate on a flat surface such as a desktop. In addition, mobile phones or other hand-held devices typically do not include conventional mouse buttons and/or a scroll wheel like dedicated wireless mice. This disclosure describes a hand-held device, such as a mobile phone, and an integrated case that includes conventional mouse buttons and/or a scroll wheel that make applications like controlling a cursor on a wirelessly connected display more efficient.

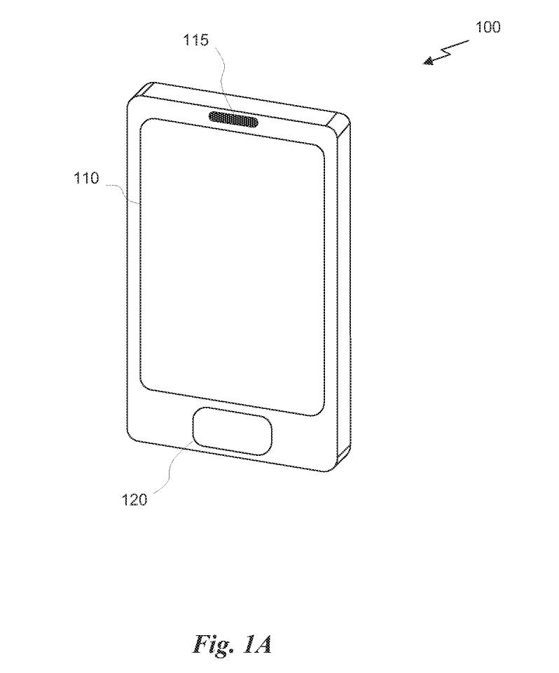

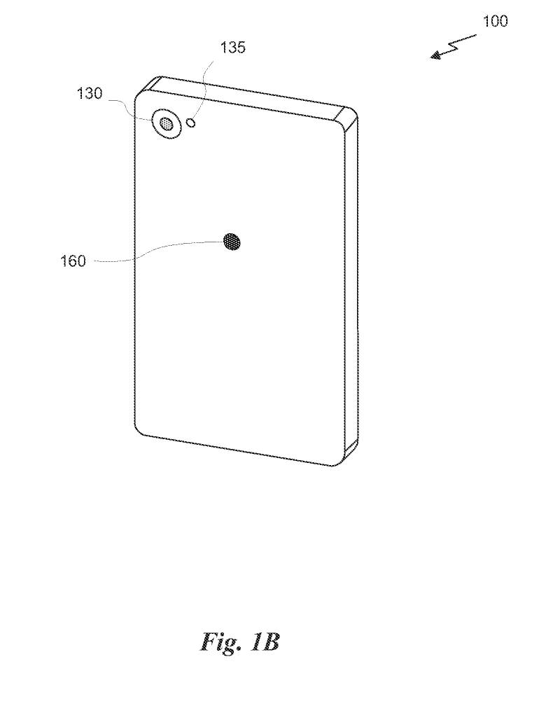

FIGS. 1A & 1B illustrate a hand-held device 100 with integrated sensors, in accordance with one embodiment. The hand-held device 100 may be, but is not limited to, a mobile phone, digital music player, digital camera, or the like. FIG. 1A shows a front side of the device 100 and FIG. 1B shows a rear side of the device 100. As shown in FIG. 1A, the device 100 includes a display device 110 such as an LCD (Liquid Crystal Display) screen, a user interface button 120, and a speaker 115. In one embodiment, the display device 110 is touch-sensitive and can accept user input at a surface of the display 110, such as with a capacitive touchscreen panel. The display device 110 may be configured to display a graphical user interface (GUI) that enables a user to interact with various features of the device 100.

As shown in FIG. 1B, the device 100 includes a camera assembly 130 that includes an image sensor. The image sensor may be a CMOS type image sensor or a CCD (charge-coupled device) type image sensor. The device 100 also includes a flash device 135, such as a LED (light emitting diode). The flash device 135 may be discharged to provide a bright light to illuminate a scene captured by the image sensor.

The device 100 also includes a position sensor 160. In one embodiment, the position sensor 160 is an optical sensor that includes a red LED diode, or the like, and receiver electronics that detect the reflection of the light on a surface and track the motion of the device. In another embodiment, the position sensor 160 is a laser sensor that is similar to the optical sensor, except the laser sensor includes a diode that emits a laser (coherent light), possibly outside the visible spectrum. The laser sensor may be more sensitive than the optical sensor and provide better resolution of motion.

In other embodiments, the device 100 may also include gyroscopes and/or accelerometers within the internal electronic components of the device 100. The gyroscopes and/or accelerometers may augment the motion signals generated by position sensor 160 to further provide better resolution of motion. In yet other embodiments, device 100 may include gyroscopes and/or accelerometers in lieu of the position sensor 160, where the gyroscopes and/or accelerometers provide the signals for tracking the motion of the device 100.

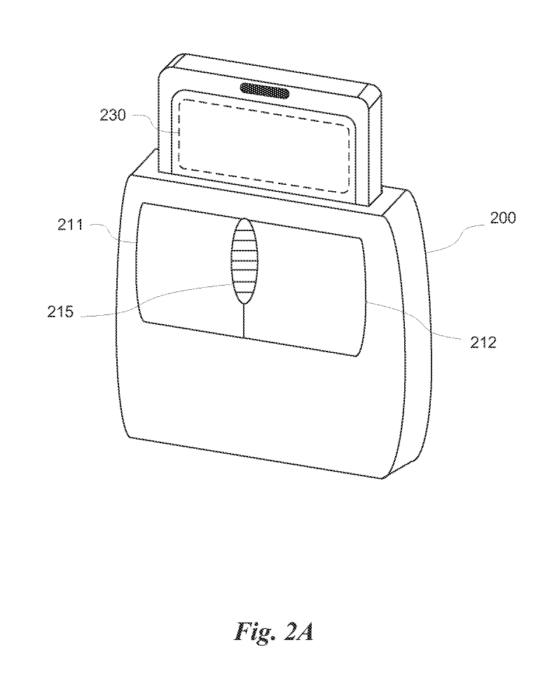

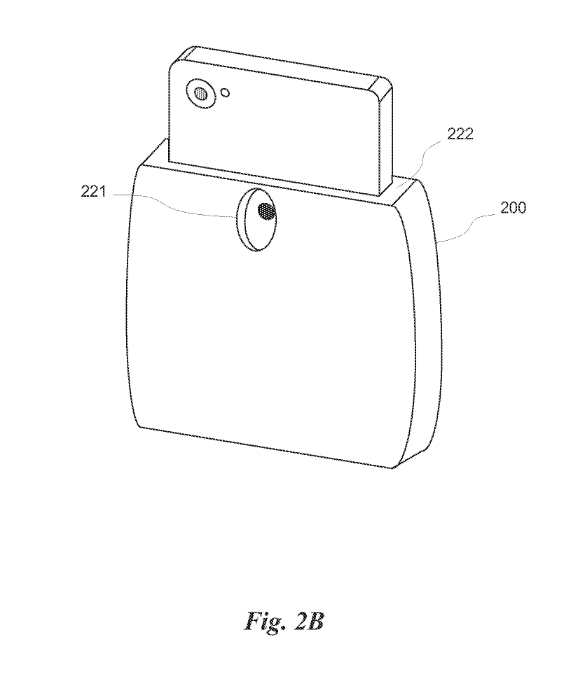

FIGS. 2A & 2B illustrate a case 200 for the hand-held device 100 of FIGS. 1A and 1B, in accordance with one embodiment. The case 200 provides additional functionality to the device 100 and has an ergonomic design that fits more comfortably in a user's hand. FIG. 2A shows a front side of the case 200 and FIG. 2B shows a rear side of the case 200. As shown in FIG. 2A, the case includes a left mouse button 211, a right mouse button 212, and a scroll wheel 215. In some embodiments, one or more of the left mouse button 211, the right mouse button 212, or the scroll wheel 215 may not be included in the case, For example, the case 200 may include only one mouse button such as a case configured as a mouse compatible with a Macintosh computer. In another example, the case 200 may not include a scroll wheel 215. In yet other embodiments, the case 200 may include additional buttons and/or elements such as a touchpad or a trackball. It will be appreciated that the case 200 includes integrated electronics that detect signals generated when a user presses the left mouse button 211 or the right mouse button 212 as well as when the user rotates the scroll wheel 215. In one embodiment, the case 200 is powered by one or more batteries. In another embodiment, the case 200 is powered through an external connector (not shown) such as a connector on the inside of the case 200 that is inserted into a corresponding connector on the device 100, thereby being powered through a power supply of the device 100 supplied through the connector.

As shown in FIG. 2B, the rear surface of the case 200 includes a cutout 221 that enables the position sensor 160 to detect motion of the device 100 relative to a surface (e.g., a document). Light is emitted from the LED diode of the position sensor 160 and reflected off the surface. As the light returns to the position sensor 160, the position sensor 160 detects if the device has moved since the light was emitted and in what direction the motion occurred. In one embodiment, the position sensor 160 is located above a top surface 222 of the case 200 such that the cutout 221 is not needed in order for the position sensor 160 to detect motion.

Returning now to FIG. 2A, in one embodiment, a portion of the device 100 protrudes from the top of the case 200 exposing a portion 230 of the display 110. The portion 230 may be used to provide additional functionality to the device 100. For example, one or more GUI elements may be displayed in the portion 230 that provide special functionality for the device 100, such as dedicated GUI elements for the cut/copy/paste functions. Another example is where a menu context may be displayed in the portion 230 that allows a user to execute a particular process such as saving a document, opening an email client, or play/pause/fast-forward media functionality. It will be appreciated that the GUI elements may be associated with a wide assortment of functionalities that may be displayed in the portion 230 of the display 110 in association with the device 100 being utilized as a wireless mouse.

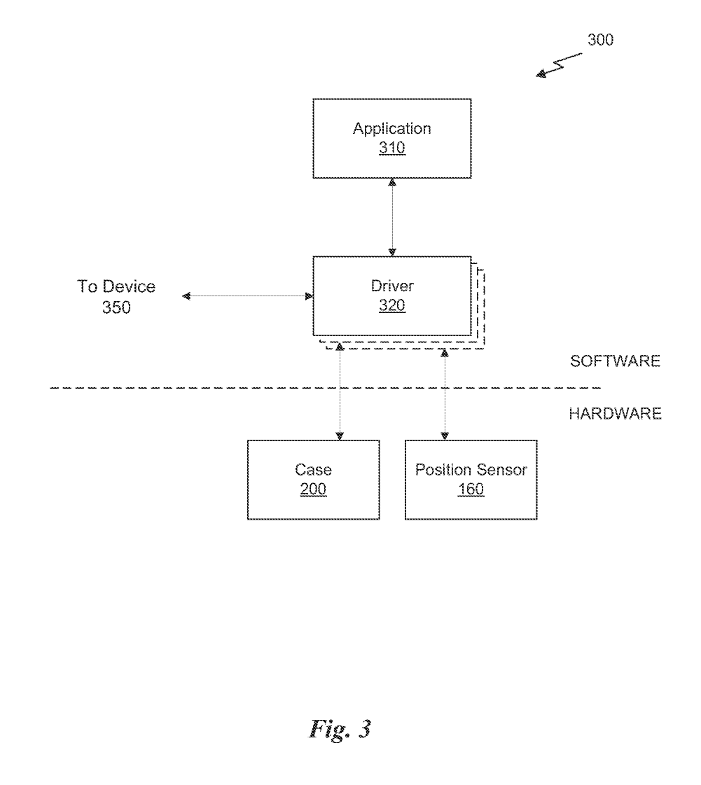

FIG. 3 illustrates a system 300 for configuring a hand-held device 100 as a wireless mouse, in accordance with one embodiment. As shown in FIG. 3, the system 300 includes the device 100, which includes an integrated case 200, configured as a wireless mouse to control operation of a wirelessly-connected device 350, such as a high-definition television, desktop computer, laptop computer, gaming system, or the like. The device 100 includes an application 310 and one or more drivers 320. The drivers 320 may be part of an operating system (not shown) configured to manage the operation of software on device 100. In one embodiment, the drivers 320 are configured to interact with one or more hardware units, such as the position sensor 160 and the case 200. The drivers 320 implement application programming interfaces (APIs) that provide an abstraction layer to one or more applications such as application 310. In one example, the application 310 may include instructions that call the methods defined by one of the APIs to enable the application 310 to receive feedback about the motion of the device 100 from the position sensor 160.

In one embodiment, the application 310 includes a GUI that displays one or more GUI elements on display 110 of the device 100. Again, the GUI may include a GUI element displayed in the portion 230 of the display 110 that enables a user to implement special functionality associated with mouse operations. The application 310, via a driver 320, also includes functionality to connect wirelessly with a wirelessly-connected device 350. The device 100 may connect with the device 350 via a wireless networking protocol such as one of the IEEE (institute of Electrical and Electronics Engineers) 802.11 standards. In other embodiments, the device 100 may connect with the device 350 via Bluetooth wireless communication, infrared data association (IrDA), or other types of near field communication standards or wireless protocols. The device 350 receives communications from device 100 via a wireless connection established through one of the drivers 320. For example, the driver 320 may establish communication with the device 350 via a wireless receiver attached to a USB (Universal Serial Bus) port of the device 350, and a USB driver for a mouse may be configured in the device 350 to receive communications from the device 100 as if the device 100 were a wireless mouse. The communications are formatted according to a standard USB protocol for a USB mouse. The device 100 is configured to control the movement of the cursor and transmit information about button clicks to device 350.

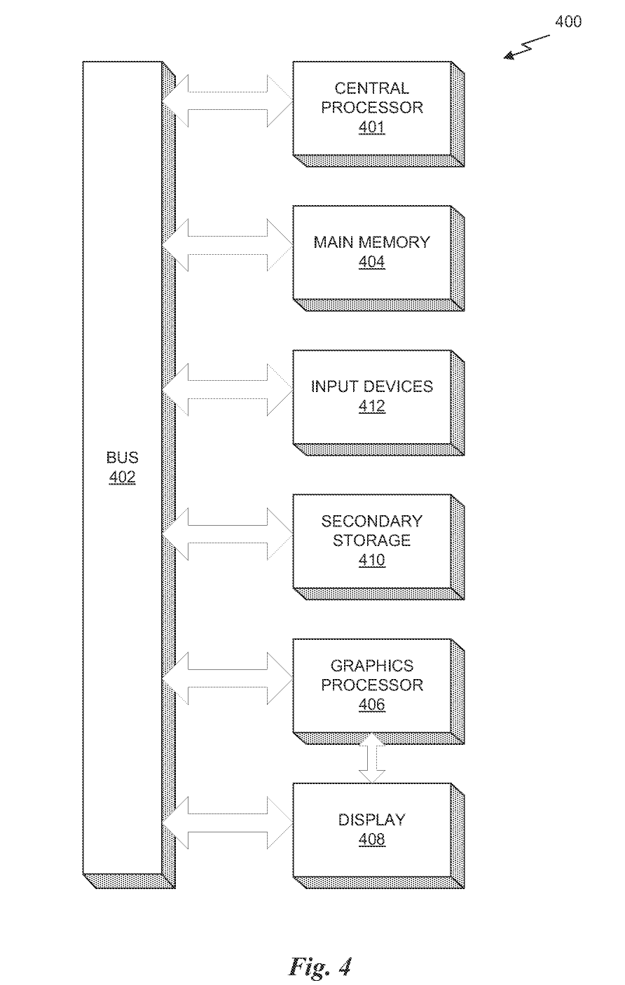

FIG. 4 illustrates an exemplary system 400 in which the various architecture and/or functionality of the various previous embodiments may be implemented. As shown, a system 400 is provided including at least one central processor 401 that is connected to a communication bus 402. The communication bus 402 may be implemented using any suitable protocol, such as PCI (Peripheral Component Interconnect), PCI-Express, AGP (Accelerated Graphics Port), HyperTransport, or any other bus or point-to-point communication protocol(s). The system 400 also includes a main memory 404. Control logic (software) and data are stored in the main memory 404 which may take the form of random access memory (RAM).

The system 400 also includes input devices 412, a graphics processor 406, and a display 408, i.e. a LCD (liquid crystal display), LED (light emitting diode), or the like. User input may be received from the input devices 412, e.g., keyboard, mouse, touchpad, microphone, and the like. In one embodiment, the input devices 412 may include the device 100 with integrated case 200. Thus, the device 100 may be utilized like a conventional wireless mouse. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 404 and/or the secondary storage 410. Such computer programs, when executed, enable the system 400 to perform various functions. The memory 404, the storage 410, and/or any other storage are possible examples of computer-readable media.

In one embodiment, the architecture and/or functionality of the various previous figures may be implemented in the context of the central processor 401, the graphics processor 406, an integrated circuit (not shown) that is capable of at least a portion of the capabilities of both the central processor 401 and the graphics processor 406, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of various devices including, but not limited to, a personal digital assistant (PDA) device, a mobile phone device, etc.

Further, while not shown, the system 400 may be coupled to a network (e.g., a telecommunications network, local area network (LAN), wireless network, wide area network (WAN) such as the Internet, peer-to-peer network, cable network, or the like) for communication purposes.

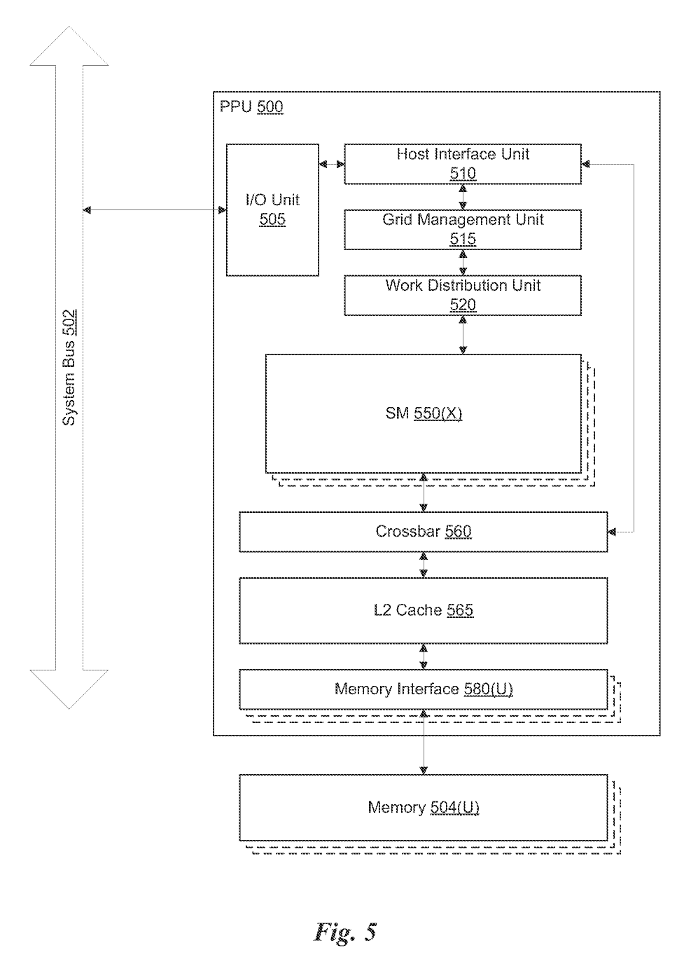

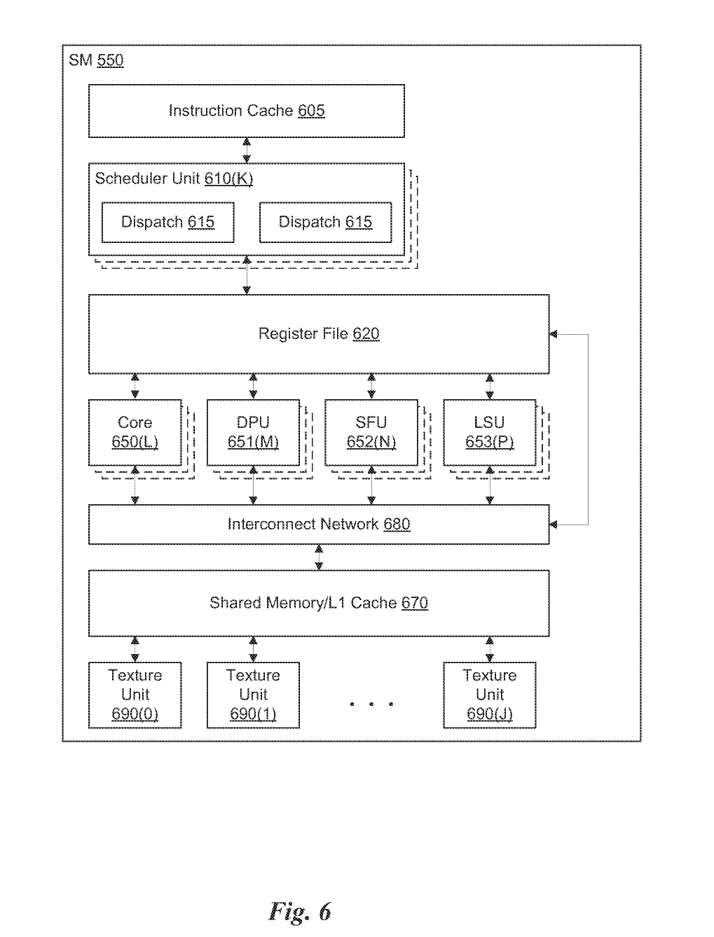

FIG. 5 illustrates a parallel processing unit (PPU) 500, according to one embodiment. While a parallel processor is provided herein as an example of the PPU 500, it should be strongly noted that such processor is set forth for illustrative purposes only, and any processor may be employed to supplement and/or substitute for the same. In one embodiment, the PPU 500 is configured to execute a plurality of threads concurrently in two or more streaming multi-processors (SMs) 550. A thread (i.e., a thread of execution) is an instantiation of a set of instructions executing within a particular SM 550. Each SM 550, described below in more detail in conjunction with FIG. 6, may include, but is not limited to, one or more processing cores, one or more load/store units (LSUs), a level-one (L1) cache, shared memory, and the like.

In one embodiment, the PPU 500 includes an input/output (I/O) unit 505 configured to transmit and receive communications (i.e., commands, data, etc.) from a central processing unit (CPU) (not shown) over the system bus 502. The I/O unit 505 may implement a Peripheral Component Interconnect Express (PCIe) interface for communications over a PCIe bus. In alternative embodiments, the I/O unit 505 may implement other types of well-known bus interfaces.

The PPU 500 also includes a host interface unit 510 that decodes the commands and transmits the commands to the grid management unit 515 or other units of the PPU 500 (e.g., memory interface 580) as the commands may specify. The host interface unit 510 is configured to route communications between and among the various logical units of the PPU 500.

In one embodiment, a program encoded as a command stream is written to a buffer by the CPU. The buffer is a region in memory, e.g., memory 504 or system memory, that is accessible (i.e., read/write) by both the CPU and the PPU 500. The CPU writes the command stream to the buffer and then transmits a pointer to the start of the command stream to the PPU 500. The host interface unit 510 provides the grid management unit (GMU) 515 with pointers to one or more streams. The GMU 515 selects one or more streams and is configured to organize the selected streams as a pool of pending grids. The pool of pending grids may include new grids that have not vet been selected for execution and grids that have been partially executed and have been suspended.

A work distribution unit 520 that is coupled between the GMU 515 and the SMs 550 manages a pool of active grids, selecting and dispatching active grids for execution by the SMs 550. Pending grids are transferred to the active grid pool by the GMU 515 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 520. In addition to receiving grids from the host interface unit 510 and the work distribution unit 520, the GMU 510 also receives grids that are dynamically generated by the SMs 550 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 500. An application may include instructions (i.e., API calls) that cause the driver kernel to generate one or more grids for execution. In one embodiment, the PPU 500 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 500 comprises X SMs 550(X). For example, the PPU 100 may include 15 distinct SMs 550. Each SM 550 is multi-threaded and configured to execute a plurality of threads (e.g., 32 threads) from a particular thread block concurrently. Each of the SMs 550 is connected to a level-two (L2) cache 565 via a crossbar 560 (or other type of interconnect network). The L2 cache 565 is connected to one or more memory interfaces 580. Memory interfaces 580 implement 16, 32, 64, 128-bit data buses, or the like, for high-speed data transfer. In one embodiment, the PPU 500 comprises U memory interfaces 580(U), where each memory interface 580(U) is connected to a corresponding memory device 504(U). For example, PPU 500 may be connected to up to 6 memory devices 504, such as graphics double-data-rate, version 5, synchronous dynamic random access memory (GDDR5 SDRAM).

In one embodiment, the PPU 500 implements a multi-level memory hierarchy. The memory 504 is located off-chip in SDRAM coupled to the PPU 500. Data from the memory 504 may be fetched and stored in the L2 cache 565, which is located on-chip and is shared between the various SMs 550. In one embodiment, each of the SMs 550 also implements an L1 cache. The L1 cache is private memory that is dedicated to a particular SM 550. Each of the L1 caches is coupled to the shared L2 cache 565. Data from the L2 cache 565 may be fetched and stored in each of the L1 caches for processing in the functional units of the SMs 550.

In one embodiment, the PPU 500 comprises a graphics processing unit (GPU). The PPU 500 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system as well as attributes associated with each vertex of the primitive. The PPU 500 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, shader, geometry shader, pixel shader, etc. For example, the GMU 515 may configure one or more SMs 550 to execute a vertex shader program that processes a number of vertices defined by the model data. In one embodiment, the GMU 515 may configure different SMs 550 to execute different shader programs concurrently. For example, a first subset of SMs 550 may be configured to execute a vertex shader program while a second subset of SMs 550 may be configured to execute a pixel shader program. The first subset of SMs 550 processes vertex data to produce processed vertex data and writes the processed vertex data to the L2 cache 565 and/or the memory 504. After the processed vertex data is rasterized (i.e., transformed from three-dimensional data into two-dimensional data in screen space) to produce fragment data, the second subset of SMs 550 executes a pixel shader to produce processed fragment data, which is then blended with other processed fragment data and written to the frame buffer in memory 504. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 500 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 500 is embodied on a simple semiconductor substrate. In another embodiment, the PPU 500 is included in a system-on-a-chip (SoC) along with one or more other logic units such as a reduced instruction set computer (RISC) CPU, a memory management unit (MMU), a digital-to-analog converter (DAC), and the like. For example, PPU 500 may be included in system 400 of FIG. 4.

In one embodiment, the PPU 500 may be included on a graphics card that includes one or more memory devices 504 such as GDDR5 SDRAM. The graphics card may be configured to interface with a PCIe slot on a motherboard of a desktop computer that includes, e.g., a northbridge chipset and a southbridge chipset. In yet another embodiment, the PPU 500 may be an integrated graphics processing unit (iGPU) included in the chipset (i.e., Northbridge) of the motherboard.

FIG. 6 illustrates the streaming multi-processor 550 of FIG. 5, according to one embodiment. As shown in FIG. 6, the SM 550 includes an instruction cache 605, one or more scheduler units 610, a register file 620, one or more processing cores 650, one or more double precision units (DPUs) 651, one or more special function units (SFUs) 652, one or more load/store units (LSUs) 653, an interconnect network 680, a shared memory/L1 cache 670, and one or more texture units 690.

As described above, the work distribution unit 520 dispatches active grids for execution on one or more SMs 550 of the PPU 500. The scheduler unit 610 receives the grids from the work distribution unit 520 and manages instruction scheduling for one or more thread blocks of each active grid. The scheduler unit 610 schedules threads for execution in groups of parallel threads, where each group is called a warp. In one embodiment, each warp includes 32 threads. The scheduler unit 610 may manage a plurality of different thread blocks, allocating the thread blocks to warps for execution and then scheduling instructions from the plurality of different warps on the various functional units i.e., cores 650, DPUs 651, SFUs 652, and LSUs 653) during each clock cycle.

In one embodiment, each scheduler unit 610 includes one or more instruction dispatch units 615. Each dispatch unit 615 is configured to transmit instructions to one or more of the functional units. In the embodiment shown in FIG. 6, the scheduler unit 610 includes two dispatch units 615 that enable two different instructions from the same warp to be dispatched during each clock cycle. In alternative embodiments, each scheduler unit 610 may include a single dispatch unit 615 or additional dispatch units 615.

Each SM 650 includes a register file 620 that provides a set of registers for the functional units of the SM 650. In one embodiment, the register file 620 is divided between each of the functional units such that each functional unit is allocated a dedicated portion of the register file 620. In another embodiment, the register file 620 is divided between the different warps being executed by the SM 550. The register file 620 provides temporary storage for operands connected to the data paths of the functional units.

Each SM 550 comprises L processing cores 650. In one embodiment, the SM 550 includes a large number (e.g., 192, etc.) of distinct processing cores 650. Each core 650 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 550 also comprises M DPUs 651 that implement double-precision floating point arithmetic, N SFUs 652 that perform special functions (e.g., copy rectangle, pixel blending operations, and the like), and P LSUs 653 that implement load and store operations between the shared memory/L1 cache 670 and the register file 620. In one embodiment, the SM 550 includes 64 DPUs 651, 32 SFUs 652, and 32 LSUs 653.

Each SM 550 includes an interconnect network 680 that connects each of the functional units to the register file 620 and the shared memory/L1 cache 670. In one embodiment, the interconnect network 680 is a crossbar that can be configured to connect any of the functional units to any of the registers in the register file 620 or the memory locations in shared memory/L1 cache 670.

In one embodiment, the SM 550 is implemented within a GPU. In such an embodiment, the SM 550 comprises J texture units 690. The texture units 690 are configured to load texture maps (i.e., a 2D array of texels) from the memory 504 and sample the texture maps to produce sampled texture values for use in shader programs. The texture units 690 implement texture operations such as anti-aliasing operations using mip-maps (i.e., texture maps of varying levels of detail). In one embodiment, the SM 550 includes 16 texture units 690.

The PPU 500 described above may be configured to perform highly parallel computations much faster than conventional CPUs. Parallel computing has advantages in graphics processing, data compression, biometrics, stream processing algorithms, and the like.

In one embodiment, PPU 500 may be implemented within system 400 and configured to render a cursor associated with the device 100. A plurality of threads may be generated and executed on PPU 500 to generate pixel data for the display, at least one thread being configured to render a digital representation of the mouse cursor. The threads may be executed by one or more SMs 550 of PPU 500.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus comprising:
a hand-held device that includes a position sensor; and
a case connected to the hand-held device, wherein the case includes at least one button for providing user input.

2. The apparatus of claim 1, wherein the case comprises two or more buttons.

3. The apparatus of claim 1, wherein the case comprises a scroll wheel.

4. The apparatus of claim 1, wherein the hand-held device is a mobile phone that includes a display.

5. The apparatus of claim 4, wherein the case is configured to expose a portion of the display.

6. The apparatus of claim 5, wherein the display of the hand-held device is configured to display one or more graphical user interface elements to a user in the portion of the display and receive feedback from the one or more graphical user interface elements when the user touches the display in a location associated with the one or more graphical user interface elements.

7. The apparatus of claim 1, wherein the case is connected to the hand-held device via a connector integrated into the hand-held device.

8. The apparatus of claim 7, wherein a power supply of the hand-held device is supplied to the case via the connector.

9. The apparatus of claim 1, wherein the case is connected to the hand-held device via a wireless communications protocol.

10. The apparatus of claim 9, wherein the wireless communications protocol is Bluetooth.

11. The apparatus of claim 1, wherein the position sensor is an optical position sensor.

12. The apparatus of claim 1, wherein the position sensor comprises at least one of a gyroscope and an accelerometer.

13. A system comprising:
a device configured to communicate via a wireless protocol;
a hand-held device that includes a position sensor; and
a case connected to the hand-held device, wherein the case includes at least one button for providing user input.

14. The system of claim 13, wherein the hand-held device is a mobile phone.

15. The system of claim 13, wherein the wirelessly connected device is a high-definition television.

16. The system of claim 13, wherein the case is configured to expose a portion of the display.

17. The system of claim 16, wherein a display of the hand-held device is configured to display one or more graphical user interface elements to a user in a portion of the display.

18. The system of claim 13, wherein the device is connected to the wirelessly-connected device via a wireless communications protocol.

19. The system of claim 18, wherein the wirelessly-connected device includes a wireless receiver connected to a USB (Universal Serial Bus) port.

20. The system of claim 19, wherein the wireless communications protocol is Bluetooth.
